(19) United States
(12) Patent Application Publication
(10) Pub. No.: US 2019/0076892 A1
(43) Pub. Date: Mar. 14, 2019

(54) CLEANING APPARATUS AND CLEANING METHOD FOR NOZZLE OF COATING MACHINE

(71) Applicant: SHENZHEN CHINA STAR OPTOELECTRONICS TECHNOLOGY CO., LTD., Shenzhen, Guangdong (CN)

(72) Inventor: Kai ZHAO, Shenzhen (CN)

(21) Appl. No.: 15/574,245

(22) PCT Filed: Nov. 2, 2017
(86) PCT No.: PCT/CN2017/109105

§ 371 Date: Nov. 15, 2017

(30) Foreign Application Priority Data
Sep. 12, 2017 (CN) 201710814959.2

(51) Int. Cl. B08B 9/02; B08B 3/08; B08B 3/10; B05B 15/55

(52) U.S. Cl. CPC B08B 9/021; B08B 3/08; B08B 2203/0264; B05B 15/55; B08B 3/10

(57) ABSTRACT

A cleaning apparatus and a cleaning method for a nozzle of a coating machine are provided. A second pipe supplies a cleaning agent and a high pressure pump pressurizes the cleaning agent in the second pipe, so that the nozzle of the coating machine is cleaned. Thus, costs are reduced, cleaning is improved, and efficiency of cleaning the nozzle of the coating machine is greatly enhanced.

### FIELD OF THE INVENTION

The present disclosure relates to the field of optical process technology, and more particularly to a cleaning apparatus and a cleaning method for a nozzle of a coating machine.

### BACKGROUND OF THE DISCLOSURE

In manufacturing liquid crystal panels, it is required to transfer an alignment solution of a liquid crystal panel to a printing nozzle, and then print the alignment solution, using the printing nozzle, on the substrate. After drying, the alignment solution turns into an alignment film, thereby providing liquid crystal molecules with a pre-tilt angle, improving orientation consistency of rotation of the liquid crystal molecules.

Due to high precision of the nozzle, aperture diameter of the nozzle is small, and is prone to being clogged. Therefore, cleaning of the nozzle of the coating machine directly influences product yield.

There are two methods for cleaning a nozzle of a conventional coating machine. One is to increase impact on the nozzle by pressurizing the alignment solution, but this method has a high cost. The other method is to empty stored alignment solution, and replace the alignment solution with a solvent having a low molecular weight for cleaning, but this method requires changing the liquid, and has a long process and low efficiency.

### SUMMARY OF THE INVENTION

An embodiment of the present disclosure provides a cleaning apparatus and a cleaning method for a nozzle of a coating machine, which solve the problem of the clogging of the nozzle of the coating machine, and improve the cleaning efficiency of the nozzle of the coating machine.

A embodiment of the present disclosure provides a cleaning apparatus for a nozzle of a coating machine, comprising:

a to-be-cleaned nozzle;

a first pipe configured to supply an alignment solution to the to-be-cleaned nozzle,

a second pipe configured to supply a cleaning agent to the to-be-cleaned nozzle, and

a waste liquid collection tank; wherein the first pipe is provided with a first valve, and the second pipe is provided with a high pressure pump and a second valve;

when the first valve is opened, the second valve is closed;

wherein the waste collection tank is disposed on an output side of the to-be-cleaned nozzle, and a protective cover is disposed on the waste collection tank;

wherein the cleaning apparatus includes four execution states sequentially executed:

in a first execution state, the first valve is closed, and the alignment solution is blocked from flowing into the nozzle;

in a second execution state, the first valve and the second valve are closed, and the protective cover of the waste collection tank is engaged with the nozzle to prevent waste liquid from splashing;

in a third execution state, the first valve is closed, the second valve is opened, the to-be-cleaned nozzle is cleaned with the cleaning agent, and the high pressure pump is turned on to pressurize the cleaning agent; and

in a fourth execution state, the first valve is closed, the second valve is closed, the high pressure pump is in a non-operation state, and the cleaning agent is blocked from flowing into the nozzle; and

wherein the cleaning agent is N-methylpyrrolidone.

A embodiment of the present disclosure further provides a cleaning apparatus for a nozzle of a coating machine, comprising:

a to-be-cleaned nozzle;

a first pipe configured to supply an alignment solution to the to-be-cleaned nozzle,

a second pipe configured to supply a cleaning agent the to-be-cleaned nozzle, and

a waste liquid collection tank;

wherein the first pipe is provided with a first valve, and the second pipe is provided with a high pressure pump and a second valve;

wherein the waste collection tank is disposed on an output side of the to-be-cleaned nozzle, and a protective cover is disposed on the waste collection tank; and

wherein the cleaning apparatus includes four execution states sequentially executed:

in a first execution state, the alignment solution is blocked from flowing into the nozzle;

in a second execution state, the protective cover of the waste collection tank engages with the nozzle to prevent waste liquid from splashing;

in a third execution state, the to-be-cleaned nozzle is cleaned with the cleaning agent, and the high pressure pump is turned on to pressurize the cleaning agent; and

in a fourth execution state, the cleaning agent is blocked from flowing into the nozzle.

A embodiment of the present disclosure further provides a method for cleaning a nozzle of a coating machine comprising a nozzle, a first pipe configured to supply an alignment solution to the nozzle, a second pipe configured to supply a cleaning agent to the nozzle, a high pressure pump configured to pressurize the second pipe and a waste liquid collection tank, comprising steps of:

turning off the first pipe configured to supply the alignment solution to the nozzle when the nozzle in a clogged state is detected;

engaging the protective cover of the waste collection tank with the nozzle to prevent waste liquid from splashing;

cleaning the nozzle with the cleaning agent supplied by the second pipe, and turning on the high pressure pump to pressurize the cleaning agent in the second pipe; and

turning off the second pipe configured to supply the cleaning agent to the nozzle after cleaning of the cleaning agent is done.

In the cleaning apparatus and the cleaning method for the nozzle of the coating machine provided in the present disclosure, the nozzle of the coating machine is cleaned using the second pipe supplying the cleaning agent and the high pressure pump pressurizing the cleaning agent in the second pipe. Under the premise of reducing costs, the cleaning is improved, and the efficiency of cleaning the nozzle of the coating machine is greatly enhanced.

### BRIEF DESCRIPTION OF THE DRAWINGS

FIG. 1 is a structural schematic diagram of a cleaning apparatus for a nozzle of a coating machine provided by an embodiment in the present disclosure.

FIG. 2 is another structural schematic diagram of the cleaning apparatus for the nozzle of the coating machine provided by an embodiment in the present disclosure.

FIG. 3 is a schematic flowchart of the cleaning method for the nozzle of the coating machine provided by an embodiment in the present disclosure.

### DETAILED DESCRIPTION OF THE PREFERRED EMBODIMENTS

Refer to the figures in the accompanying drawings. The components with the same reference numbers represent the same or similar components. The following description is based on the illustrated specific embodiments of the present disclosure, and should not be construed to limit the other specific embodiments which are not described in detail herein.

The term “embodiment” as used in this specification means serving as an example, implementation, or illustration. Furthermore, the articles “a” or “an” as used in the specification and the appended claims may generally be construed to mean “one or more” unless it is clearly specified to be the singular form in the context.

In the description of the present disclosure, it is to be understood that the azimuth or positional relationships indicated by the terms “center”, “longitudinal”, “transverse”, “length”, “width”, “thickness”, “upper”, “lower”, “front”, “back”, “left”, “right”, “vertical”, “horizontal”, “top”, “bottom”, “inside”, “outside”, “clockwise”, “counter-clockwise”, etc., are based on the azimuth or positional relationship shown in the drawings, merely for the purpose of assisting and simplify the description, rather than indicating or implying that the indicated device or element must have a specific orientation, and be constructed and operated in a particular orientation. Therefore, these terms cannot be construed as limiting the present disclosure.

In the description of the present disclosure, it is to be understood that the terms “dispose/disposition”, “connect/connection”, “configure/configuration” should be broadly understood, unless otherwise specified and defined, for example, as a fixed connection or a removable connection, an integral connection, a mechanical connection, an electrical connection, a communication with each other, a direct connection, an indirect connection via intermediate medium, an internal communication between two elements, or an inter-reaction relationship between two elements. The specific meaning of the above-mentioned terms in the present disclosure may be understood by a person of ordinary skill in the art in light of specific circumstances.

In addition, unless otherwise expressly stated and defined, the description that “a first feature is on or under a second feature” may mean that the first feature directly contacts the second feature, or mean that the first feature contacts the second feature via another feature therebetween, rather than directly contact the second feature. Moreover, the description that “the first feature is on/above/over the second feature” may mean that the first feature is directly or obliquely on/above/over the second feature, or just mean the horizontal height of the first feature is higher than that of the second feature. The description that “the first feature is under/below/beneath the second feature” may mean that the first feature is directly or obliquely under/below/beneath the second feature, or just mean the horizontal height of the first feature is lower than that of the second feature.

The following description provides a number of different embodiments or examples for implementing the different structures of the present disclosure. In order to simplify the present disclosure, components and arrangements of specific examples are described below. Certainly, the examples are merely exemplary and are not intended to limit the present disclosure. In addition, for the sake of simplicity and clarity, the reference numerals and/or the reference letters may repeat in different examples in the present disclosure, which does not indicate the relationship between the various discussed embodiments and/or arrangements. Moreover, the examples of various specific processes and materials are provided in the present disclosure, but a person of ordinary skill in the art will appreciate the application of other processes and/or the use of other materials.

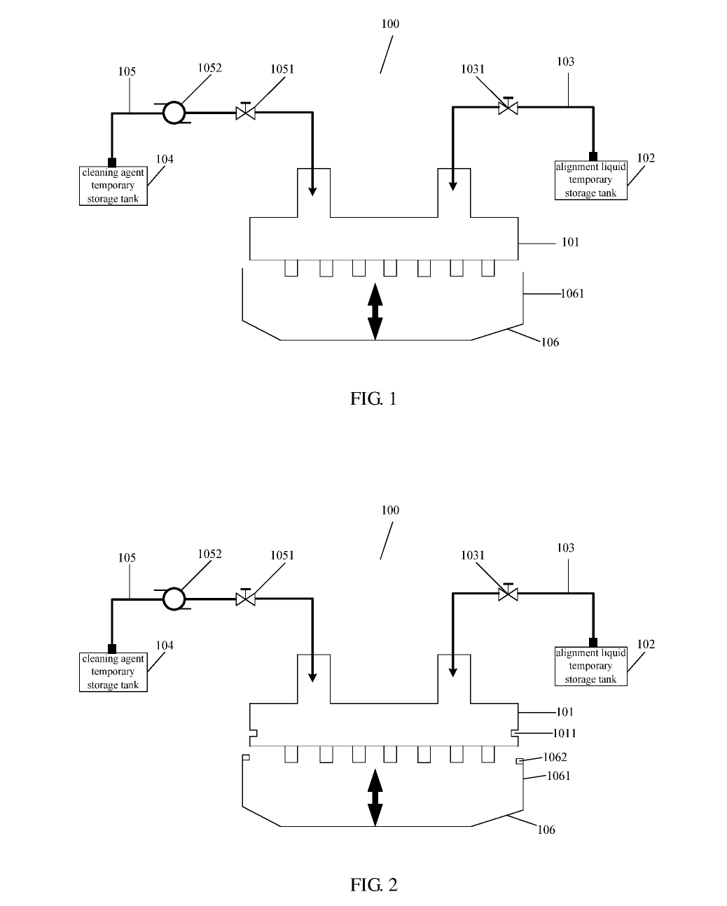

FIG. 1 is a structural schematic diagram of a cleaning apparatus for a nozzle of a coating machine provided by an embodiment in the present disclosure. A cleaning apparatus for a nozzle of a coating machine in the present embodiment includes a to-be-cleaned nozzle 101, an alignment solution temporary storage tank 102, a first pipe 103 configured to supply an alignment solution (PI solution) to the to-be-cleaned nozzle, a cleaning agent temporary storage tank 104, a second pipe 105 configured to supply a cleaning agent to the to-be-cleaned nozzle 101, and a waste liquid collection tank 106.

The first pipe 103 is provided with a first valve 1031, and one end of the first pipe 103 is connected to the alignment liquid temporary storage tank 102 and the other end of the first pipe 103 is connected to the to-be-cleaned nozzle 101. The first valve 1031 is disposed between the alignment liquid temporary storage tank 102 and the to-be-cleaned nozzle 101. The first valve 1031 is opened by default.

The second pipe 105 is provided with a second valve 1051 and a high pressure pump 1052. One end of the second pipe 105 is connected to the cleaning agent temporary storage tank 104, and the other end is connected to the to-be-cleaned nozzle 101. The second valve 1051 and the high pressure pump 1052 are disposed between the cleaning agent temporary storage tank 104 and the to-be-cleaned nozzle 101. The second valve 1051 is closed by default.

The waste collection tank 106 is disposed on an output side of the to-be-cleaned nozzle 101 for receiving waste liquid discharged from the nozzle 101. The waste collection tank 106 includes a protective cover 1061.

The cleaning apparatus includes four execution states sequentially executed. In a first execution state, the first valve 1031 is closed, and the alignment solution is blocked from flowing into the nozzle. In a second execution state, the first valve and the second valve are closed, and the protective cover 1061 of the waste collection tank 106 is engaged with the nozzle 101 to prevent waste liquid from splashing. In a third execution state, the second valve 1051 is opened, the to-be-cleaned nozzle 101 is cleaned with the cleaning agent, and the high pressure pump 1052 is turned on to pressurize the cleaning agent. In a fourth execution state, the first valve is closed, the second valve 1041 is closed, and the cleaning agent is blocked from flowing into the nozzle. In an embodiment, the cleaning agent is N-methylpyrrolidone (NMP). In an embodiment, the cleaning apparatus 100 includes a control circuit connected to the high pressure pump 1052, to control operation of the high pressure pump.

In some possible embodiments, as shown in FIG. 2, recesses 1011 are defined at both ends of the to-be-cleaned nozzle 101, projections 1062 corresponding to the recesses 1011 are disposed at both ends of the protection cover 1061 of the waste collection tank 106. In the second execution state, the projections 1062 disposed at both ends of the protective cover 1061 of the waste collection tank 106 is correspondingly engaged with the to-be-cleaned nozzle 101, to achieve engagement of the protective cover 1061 of the waste collection tank 106 with the nozzle 101, thereby preventing waste liquid from splashing.

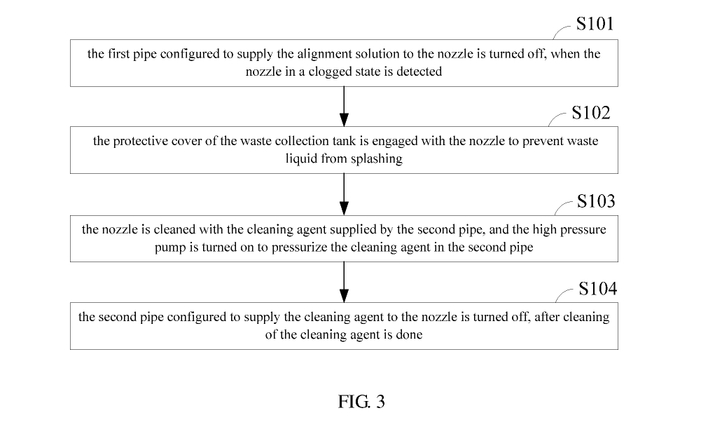

Refer to FIG. 3, which is a schematic flowchart of the cleaning method for the nozzle of the coating machine provided by an embodiment in the present disclosure. A method for cleaning a nozzle of a coating machine is utilized in a cleaning apparatus for a nozzle of a coating machine, which includes a nozzle, a first pipe configured to supply an alignment solution to the nozzle, a second pipe configured to supply a cleaning agent to the nozzle, a high pressure pump configured to pressurize the second pipe and a waste liquid collection tank.

Specifically, the method includes the following steps:

In Step S101, the first pipe configured to supply the alignment solution to the nozzle is turned off, when the nozzle in a clogged state is detected.

When the nozzle in the clogged state is detected, the nozzle is required to be cleaned, the valve on the first line is closed, and the first pipe configured to supply the alignment solution to the nozzle is turned off.

In Step S102, the protective cover of the waste collection tank is engaged with the nozzle to prevent waste liquid from splashing.

In one embodiment, the protective cover may be disposed on the waste collection tank. After the first pipe configured to supply the alignment solution to the nozzle is turned off, the protective cover of the waste collection tank is engaged with the nozzle to prevent waste liquid from splashing.

In Step S103, the nozzle is cleaned with the cleaning agent supplied by the second pipe, and the high pressure pump is turned on to pressurize the cleaning agent in the second pipe.

The cleaning agent may be N-methylpyrrolidone, which is a rinsing solvent with a low molecular weight. The valve on the second line is opened, the to-be-cleaned nozzle is cleaned with the cleaning agent supplied by the second line, simultaneously the high pressure pump is turned on via the control circuit, and the high pressure pump continuously pressurizes the cleaning agent in the second line, thereby increasing the flow rate of the cleaning agent and rinsing strength, and effectively cleaning the to-be-cleaned nozzle.

Step S104, the second pipe configured to supply the cleaning agent to the nozzle is turned off, after cleaning of the cleaning agent is done.

In one embodiment, after the step of turning off the second pipe configured to supply the cleaning agent to the nozzle after the cleaning of the cleaning agent is done, the method further includes steps of turning on the first pipe configured to supply the alignment solution to the nozzle and disengaging the waste liquid collection tank and the nozzle from each other when the nozzle in a non-clogged state is detected. When the nozzle in the clogged state is detected, the process for cleaning the nozzle of the coating machine continues until the nozzle in the non-clogged state is detected.

From the above, in the cleaning apparatus and the cleaning method for the nozzle of the coating machine provided in the present disclosure, the nozzle of the coating machine is cleaned using the second pipe supplying the cleaning agent and the high pressure pump pressurizing the cleaning agent in the second pipe. Under the premise of reducing costs, the cleaning is improved, and the efficiency of cleaning the nozzle of the coating machine is greatly enhanced.

Although the present disclosure is described via one or more embodiments, a person of ordinary skill in the art can come up with equivalent variations and modifications based upon the understanding of the present specification and the accompanying drawings. The present disclosure includes all such modifications and variations, and is only limited by the scope of the appended claims. In particular, as to the various functions performed by the components described above, the terms used to describe the components are intended to correspond to any component performing the specific functions (e.g., which are functionally equivalent) of the components (unless otherwise indicated), even those which are structurally different from the disclosed structure for performing the functions in the exemplary embodiments in the present specification shown herein. In addition, although a particular feature in the present specification is disclosed in only one of many embodiments, this feature may be combined with one or more features in other embodiments which are desirable and advantageous to a given or particular application. Moreover, the terms “include”, “have”, “consist of”, or variations thereof used in the detailed description or the claims are intended to be used in a manner similar to the term “comprising”.

In summary, although the preferable embodiments of the present disclosure have been disclosed above, the embodiments are not intended to limit the present disclosure. A person of ordinary skill in the art, without departing from the spirit and scope of the present disclosure, can make various modifications and variations. Therefore, the scope of the disclosure is defined in the claims.

What is claimed is:

1. A cleaning apparatus for a nozzle of a coating machine, comprising:
a to-be-cleaned nozzle;
a first pipe configured to supply an alignment solution to the to-be-cleaned nozzle,
a second pipe configured to supply a cleaning agent to the to-be-cleaned nozzle, and
a waste liquid collection tank;
wherein the first pipe is provided with a first valve, and the second pipe is provided with a high pressure pump and a second valve; when the first valve is opened, the second valve is closed;
wherein the waste collection tank is disposed on an output side of the to-be-cleaned nozzle, and a protective cover is disposed on the waste collection tank;
wherein the cleaning apparatus includes four execution states sequentially executed:
in a first execution state, the first valve is closed, and the alignment solution is blocked from flowing into the nozzle;
in a second execution state, the first valve and the second valve are closed, and the protective cover of the waste collection tank is engaged with the nozzle to prevent waste liquid from splashing;
in a third execution state, the first valve is closed, the second valve is opened, the to-be-cleaned nozzle is cleaned with the cleaning agent, and the high pressure pump is turned on to pressurize the cleaning agent; and
in a fourth execution state, the first valve is closed, the second valve is closed, the high pressure pump is in a non-operation state, and the cleaning agent is blocked from flowing into the nozzle; and
wherein the cleaning agent is N-methylpyrrolidone.

2. The cleaning apparatus for the nozzle of the coating machine as claimed in claim 1, further comprising a control circuit connected to the high pressure pump, to control operation of the high pressure pump.

3. The cleaning apparatus for the nozzle of the coating machine as claimed in claim 2, further comprising an alignment solution temporary storage tank connected to the first pipe.

4. The cleaning apparatus for the nozzle of the coating machine as claimed in claim 3, further comprising a cleaning agent temporary storage tank connected to the second pipe.

5. The cleaning apparatus for the nozzle of the coating machine as claimed in claim 4, wherein the high pressure pump is disposed between the cleaning agent temporary tank and the second valve.

6. The cleaning apparatus for the nozzle of the coating machine as claimed in claim 1, wherein recesses are defined at both ends of the to-be-cleaned nozzle, projections are disposed at both ends of the protection cover of the waste collection tank, and the projections are engaged with the recesses.

7. A cleaning apparatus for a nozzle of a coating machine, comprising:
a to-be-cleaned nozzle;
a first pipe configured to supply an alignment solution to the to-be-cleaned nozzle,
a second pipe configured to supply a cleaning agent the to-be-cleaned nozzle, and
a waste liquid collection tank;
wherein the first pipe is provided with a first valve, and the second pipe is provided with a high pressure pump and a second valve;
wherein the waste collection tank is disposed on an output side of the to-be-cleaned nozzle, and a protective cover is disposed on the waste collection tank; and
wherein the cleaning apparatus includes four execution states sequentially executed:
in a first execution state, the alignment solution is blocked from flowing into the nozzle;
in a second execution state, the protective cover of the waste collection tank engages with the nozzle to prevent waste liquid from splashing;
in a third execution state, the to-be-cleaned nozzle is cleaned with the cleaning agent, and the high pressure pump is turned on to pressurize the cleaning agent; and
in a fourth execution state, the cleaning agent is blocked from flowing into the nozzle.

8. The cleaning apparatus for the nozzle of the coating machine as claimed in claim 7, wherein
the first valve is opened, and the second valve is closed,
in a first execution state of the cleaning apparatus, the first valve is closed;
in a second execution state of the cleaning apparatus, the first valve and the second valve are closed, and the protective cover of the waste collection tank is engaged with the nozzle;
in a third execution state of the cleaning apparatus, the first valve is closed, the second valve is opened, the high pressure pump is an operation state; and
in a fourth execution state of the cleaning apparatus, the first valve is closed, the second valve is closed, and the high pressure pump is in a non-operation state.

9. The cleaning apparatus for the nozzle of the coating machine as claimed in claim 8, further comprising a control circuit connected to the high pressure pump, to control operation of the high pressure pump.

10. The cleaning apparatus for the nozzle of the coating machine as claimed in claim 9, further comprising an alignment solution temporary storage tank connected to the first pipe.

11. The cleaning apparatus for the nozzle of the coating machine as claimed in claim 10, further comprising a cleaning agent temporary storage tank connected to the second pipe.

12. The cleaning apparatus for the nozzle of the coating machine as claimed in claim 11, wherein the high pressure pump is disposed between the cleaning agent temporary tank and the second valve.

13. The cleaning apparatus for the nozzle of the coating machine as claimed in claim 7, wherein the cleaning agent is N-methylpyrrolidone.

14. A method for cleaning a nozzle of a coating machine comprising a nozzle, a first pipe configured to supply an alignment solution to the nozzle, a second pipe configured to supply a cleaning agent to the nozzle, a high pressure pump configured to pressurize the second pipe and a waste liquid collection tank , comprising steps of:
turning off the first pipe configured to supply the alignment solution to the nozzle when the nozzle in a clogged state is detected;
engaging the protective cover of the waste collection tank with the nozzle to prevent waste liquid from splashing;
cleaning the nozzle with the cleaning agent supplied by the second pipe, and turning on the high pressure pump to pressurize the cleaning agent in the second pipe; and
turning off the second pipe configured to supply the cleaning agent to the nozzle after cleaning of the cleaning agent is done.

15. The method for cleaning the nozzle of the coating machine as claimed in claim 14, wherein the cleaning agent is N-methylpyrrolidone.

16. The method for cleaning the nozzle of the coating machine as claimed in claim 14, after the step of turning off the second pipe configured to supply the cleaning agent to the nozzle after the cleaning of the cleaning agent is done, further comprising steps of:
turning on the first pipe configured to supply the alignment solution to the nozzle; and
disengaging the waste liquid collection tank and the nozzle from each other when the nozzle in a non-clogged state is detected.
